(19) United States
(12) Patent Application Publication
(10) Pub. No.: US 2020/0176139 A1
(43) Pub. Date: Jun. 4, 2020

(54) FLUID SLOSHING BEHAVIOR ANALYSIS APPARATUS AND METHOD THEREOF

(71) Applicant: ELSOLTEC, Yongin-si (KR)

(72) Inventors: Choeng Ryul CHOI, Yongin-si (KR); Won Man Park, Suwon-si (KR); Sung Man Son, Yongin-si (KR); Se Hong OH, Yongin-si (KR); Dae Kyung Choi, Yongin-si (KR)

(73) Assignee: ELSOLTEC, Yongin-si (KR)

(21) Appl. No.: 16/571,494

(22) Filed: Sep. 16, 2019

(30) Foreign Application Priority Data
Nov. 29, 2018 (KR) 10-2018-0150440

(51) Int. Cl. G21C 19/07; G21C 17/022; G21C 17/06; G06F 17/50

(52) U.S. Cl. CPC G21C 19/07; G06F 17/5009; G21C 17/06; G21C 17/022

(57) ABSTRACT

The present invention relates to an apparatus for analyzing sloshing behavior of a fluid contained in a water pool and a method thereof, the apparatus including a user input module, a first calculation module, a comparison determination module, a second calculation module, a third calculation module, a fourth calculation module, a display module, and a control module, whereby there is an advantage such that it is possible to easily, quickly, and accurately perform an analysis of sloshing behavior of the fluid contained in a large water pool such as a spent nuclear fuel storage pool for cooling and storing nuclear fuel assemblies used in nuclear power generation.

### CROSS REFERENCE TO RELATED APPLICATION

The present application claims priority to Korean Patent Application No. 10-2018-0150440, filed Nov. 29, 2018, the entire contents of which are incorporated herein by reference for all purposes.

### BACKGROUND OF THE INVENTION

### Field of the Invention

The present invention relates to an apparatus for analyzing sloshing behavior of a fluid contained in a water pool and a method thereof and, more particularly, to a computer-readable recording medium on which a program for executing the method is recorded.

### Description of the Related Art

A spent nuclear fuel storage pool is a temporary storage facility of spent nuclear fuel assemblies for cooling and storing nuclear fuel assemblies used in nuclear power generation.

The spent nuclear fuel storage pool in Korea is located in an auxiliary building of a nuclear power plant. A storage rack is placed for storing the spent nuclear fuel assemblies in the spent nuclear fuel storage pool, and the pool is filled with the cooling water for cooling the spent nuclear fuel assemblies.

When an earthquake load is transmitted to a structure of a water pool such as the spent nuclear fuel storage pool containing a large amount of water-like fluid, the fluid in the interior begins to slosh. When such sloshing occurs, not only the fluid can overflow the water pool, but also the sloshing of the fluid can act as another load on a wall or an internal structure of the water pool.

Therefore, a behavior analysis of the fluid is indispensable in a seismic safety analysis of a facility such as the spent nuclear fuel storage pool containing a large amount of fluid.

The spent nuclear fuel storage pool should be filled with a sufficient amount of the cooling water to cool the spent nuclear fuel assemblies. When the amount of the cooling water is reduced by overflowing the spent nuclear fuel storage pool, it may cause problems in cooling the spent nuclear fuel assemblies. In addition, because the cooling water is contaminated with radioactivity, when the cooling water overflowed from the water pool is released, it may be possible to cause external radiation pollution.

Besides, when an amount of the cooling water is reduced, movement of the rack in the spent nuclear fuel storage pool becomes large when an earthquake occurs. In order for a design of the water pool to prevent the cooling water overflowing and establishment of a replenishing plan for an expected amount of overflow in an event of an earthquake, it is necessary to analyze not only how much the cooling water will overflow but also how the cooling water will behave in an earthquake.

Meanwhile, the computational fluid dynamics (CFD) method has conventionally been used in an analysis of the behavior of the cooling water in the spent nuclear fuel storage pool. The CFD is a computer simulation technique that computes the dynamic behavior of a fluid as well as heat in a numerical analysis approach using a computer.

When the CFD analysis method is used, there are advantages to obtaining various results such as pressure change on the wall and change of flow velocity as well as detailed fluid behavior, in the water pool. However, the use of software requires an expensive software purchase and rental costs. In addition, the CFD analysis requires a high-performance computer, which has a disadvantage of costs for the purchase or use of the computer.

In addition, there is a problem that an analysis of a behavior of the fluid contained in a large water pool such as the spent nuclear fuel storage pool takes a long time depending on a performance of a computer.

The foregoing is intended merely to aid in the understanding of the background of the present invention, and is not intended to mean that the present invention falls within the purview of the related art that is already known to those skilled in the art.

### DOCUMENTS OF RELATED ART

### Patent Document

(Patent Document 1) Korean Patent No. 10-0957061 (Issue Date: May 13, 2010)

### SUMMARY OF THE INVENTION

Accordingly, the present invention has been made to solve the above-mentioned problems, and an objective of the present invention is to provide an apparatus for analyzing sloshing behavior of a fluid contained in a water pool and a method thereof, so as to easily, quickly, and accurately perform an analysis of sloshing behavior of a fluid contained in a large water pool such as a spent nuclear fuel storage pool for cooling and storing nuclear fuel assemblies used in nuclear power generation.

In order to achieve the above object, a first aspect of the present invention is to provide an apparatus for analyzing sloshing behavior of a fluid contained in a water pool, the apparatus including: a user input module outputting a specific input signal of a user according to a request of the user; a first calculation module receiving information data, on a width of the water pool, a height of the fluid contained in the water pool, and a width and cycle of an external excitation, output according to the specific input signal of a corresponding user from the user input module and, on a basis thereof, calculating a natural frequency of an nth (n=1, 2, 3, . . . ) mode of the fluid according to a movement of a free surface of the fluid as well as a frequency of the external excitation; a comparison determination module comparing values, of the frequency of the external excitation and the natural frequency of the nth mode of the fluid calculated from the first calculation module, with each other, thereby determining whether the frequency of the external excitation is greater than twice the natural frequency of a primary mode of the fluid contained in the water pool; a second calculation module, when the frequency of the external excitation is determined to be greater than twice the natural frequency of the primary mode of the fluid contained in the water pool by the comparison determination module, calculating a height change value of the fluid due to the frequency of the external excitation using the values, of the frequency of the external excitation and the natural frequency of the nth mode of the fluid, calculated from the first calculation module along with the information data, on the width of the water pool, the height of the fluid contained in the water pool, and the width and frequency of the external excitation, output according to the specific input signal of the corresponding user from the user input module; a third calculation module, when the frequency of the external excitation is determined to be greater than twice the natural frequency of the primary mode of the fluid contained in the water pool by the comparison determination module, calculating a height change value of the fluid due to convection of the fluid contained in the water pool using the values, of the frequency of the external excitation and the natural frequency of the nth mode of the fluid, calculated from the first calculation module along with the information data, on the width of the water pool, the height of the fluid contained in the water pool, and the width and frequency of the external excitation, output according to the specific input signal of the corresponding user from the user input module; a fourth calculation module summing the height change value of the fluid due to the frequency of the external excitation, calculated from the second calculation module, and the height change value of the fluid due to the convection of the fluid contained in the water pool, calculated from the third calculation module, thereby calculating a sloshing value of the fluid contained in the water pool; a display module, displaying on a display screen information on a sloshing behavior analysis of the fluid contained in the water pool on the basis of the sloshing value of the fluid contained in the water pool calculated from the fourth calculation module; and a control module receiving the sloshing value, calculated from the fourth calculation module according to the specific input signal of the corresponding user from the user input module, of the fluid contained in the water pool and, on the basis of the sloshing value, generating information on the sloshing behavior analysis of the fluid contained in the water pool, thereby controlling operations of the user input module, the first to fourth calculation modules, the comparison determination module, and the display module to allow the same to be displayed in a form of a text or graph on a display screen of the display module to be visually seen by the corresponding user.

Here, a storage module may be further included, the storage module, according to a control of the control module, establishing a database (DB) for at least a piece of information among pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, calculated from the first to fourth computation modules, thereby storing the same.

A communication module may be further included, the communication module, according to a control of the control module, transmitting at least a piece of information among pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, calculated from the first to fourth computation modules, to an external user terminal through a communication network.

The external user terminal may receive at least the piece of information among the pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, transmitted from the communication module through an application service previously installed and related to the sloshing behavior analysis of the fluid, thereby, on the basis of the same, displaying in the form of the text or graph on the display screen of the corresponding user terminal the same to be visually seen by the corresponding user.

A sound output module may be further included, the sound output module, according to a control of the control module, outputting the information on the sloshing behavior analysis of the fluid contained in the water pool by a sound to allow the sound to be acoustically heard by the user.

The fluid may be composed of cooling water for cooling a nuclear fuel assembly used for nuclear power generation.

The water pool may be composed of a spent nuclear fuel storage pool cooling and storing the nuclear fuel assembly used for nuclear power generation in the cooling water.

A second aspect of the present invention is a method of analyzing sloshing behavior of a fluid contained in a water pool, using an apparatus including a user input module, first to fourth calculation modules, a comparison determination module, a display module, and a control module, the method including: (a) outputting a specific input signal of a user according to a request of the user through the user input module; (b) on a basis of information data, on a width of the water pool, a height of the fluid contained in the water pool, and a width and cycle of an external excitation, output according to the specific input signal of the user in step (a), calculating a natural frequency of an nth (n=1, 2, 3, . . . ) mode of the fluid according to a free surface movement of the fluid as well as a frequency of the external excitation through a first calculation module; (c) through the comparison determination module, comparing values of the frequency of the external excitation and the natural frequency of the nth mode of the fluid calculated in step (b) with each other, thereby determining whether the frequency of the external excitation is greater than twice the natural frequency of the primary mode of the fluid contained in the water pool; (d) as a determination result in step (c), when the frequency of the external excitation is greater than twice the natural frequency of the primary mode of the fluid contained in the water pool, calculating a height change value of the fluid due to the frequency of the external excitation through the second calculation module using the values of the frequency of the external excitation and the natural frequency of the nth mode of the fluid, calculated in step (b) along with the information data, on the width of the water pool, the height of the fluid contained in the water pool, and the width and frequency of the external excitation, output according to the specific input signal of the corresponding user in step (a); (e) as a determination result in step (c), when the frequency of the external excitation is greater than twice the natural frequency of the primary mode of the fluid contained in the water pool, calculating a height change value of the fluid due to the convection of the fluid contained in the water pool through the third calculation module using the values of the frequency of the external excitation and the natural frequency of the nth mode of the fluid, calculated in step (b) along with the information data, on the width of the water pool, the height of the fluid contained in the water pool, and the width and frequency of the external excitation, output according to the specific input signal of the corresponding user in step (a); (f) through the fourth calculation module, summing the height change value of the fluid due to the frequency of the external excitation calculated in step (d) and the height change value of the fluid due to the convection of the fluid contained in the water pool calculated in step (e), thereby calculating a sloshing value of the fluid contained in the water pool; and (g) through the control module, generating information on a sloshing behavior analysis of the fluid contained in the water pool on the basis of the sloshing value of the fluid contained in the water pool calculated in step (f) according to the specific input signal of the corresponding user in step (a), thereby displaying in a form of a text or graph on a display screen of the display module the same to allow the same to be visually seen by the corresponding user.

The method may further include, after step (g), through the control module, establishing a database (DB) of at least a piece of information among pieces of information on the natural frequency of the nth mode of the fluid according to the free surface movement of the fluid calculated in step (b), the height change value of the fluid due to the frequency of the external excitation calculated in step (d), the height change value of the fluid due to the convection of the fluid contained in the water pool calculated in step (e), the sloshing value of the fluid contained in the water pool calculated in step (f), and the sloshing behavior analysis of the fluid contained in the water pool generated in step (g), thereby storing the same into a separate storage module.

The method may further include, on the basis of at least the piece of information among the pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, transmitted from the communication module through an application service installed in the external user terminal and related to the sloshing behavior analysis of the fluid, displaying in the form of the text or graph on a display screen of the corresponding user terminal the same, thereby allowing the information to be visually seen by the corresponding user.

The method may further include, after step (g), through the control module, transferring the information on the sloshing behavior analysis of the fluid contained in the water pool to a separate sound output module outputting the information by a sound, thereby allowing the sound to be acoustically heard by the user.

In step (b) of the method, the fluid may be composed of cooling water for cooling a nuclear fuel assembly used for nuclear power generation.

In step (b) of the method, the water pool may be composed of a spent nuclear fuel storage pool cooling and storing the nuclear fuel assembly used for nuclear power generation in the cooling water.

A third aspect of the present invention provides a computer-readable recording medium having recorded thereon a computer program capable of executing an above-mentioned method of analyzing sloshing behavior of a fluid contained in a water pool.

The method of analyzing the behavior of the fluid contained in the water pool according to the present invention may also be implemented as a computer-readable code on a computer-readable recording medium. Here, the computer-readable recording medium may include all kinds of recording devices in which data that may be read by a computer system is stored.

For example, the computer-readable recording medium may be a ROM, a RAM, a CD-ROM, a magnetic tape, a hard disk, a floppy disk, a removable storage device, a flash memory, an optical data storage device, and the like.

According to the apparatus for analyzing sloshing behavior of the fluid contained in the water pool and the method thereof, as described above, of the present invention, there is an advantage such that it is possible to easily, quickly, and accurately perform the analysis of sloshing behavior of the fluid contained in the large water pool such as the spent nuclear fuel storage pool for cooling and storing the nuclear fuel assemblies used in the nuclear power generation.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is an overall block diagram illustrating an apparatus for analyzing sloshing behavior of a fluid contained in a water pool according to an embodiment of the present invention;

FIG. 2 is a detailed block diagram illustrating a user terminal applied to the embodiment of the present invention;

FIGS. 3 and 4 are overall flowcharts explaining a method of analyzing sloshing behavior of a fluid contained in the water pool according to the embodiment of the present invention;

FIG. 5 is a conceptual view of the water pool explaining a calculation of sloshing of the fluid contained in the water pool in the method of analyzing the sloshing behavior of the fluid contained in the water pool according to the embodiment of the present invention; and

FIGS. 6A to 14 are graphs of simulation results comparing the proposed method of analyzing the sloshing behavior of the fluid contained in the water pool according to the embodiment of the present invention and the CFD analysis.

### DETAILED DESCRIPTION OF THE INVENTION

The foregoing objectives, features, and advantages will be described in detail with reference to the accompanying drawings. Throughout the drawings, the same reference numerals will refer to the same or like parts. Accordingly, those skilled in the art may easily implement the technical idea of the present invention. In describing the present invention, the detailed description of known techniques related to the present invention will be omitted when it is determined that the gist of the present invention may be unnecessarily obfuscated.

Terms including ordinal numbers, such as first, second, and the like may be used to describe various components, but the components are not limited to these terms. The terms are used only for the purpose of distinguishing one component from another. For example, without departing from the scope of the present invention, the first component may be referred to as a second component, and similarly, the second component may also be referred to as a first component. The terms used in this application is used only to describe a specific embodiment and is not intended to limit the invention. The singular expressions include plural expressions unless the context clearly dictates otherwise.

While the term used in the present invention is selected from general terms that are widely used at present considering the functions of the present invention, it may vary depending on an intention of a technical expert working in the related art, a precedent, an emergence of new technology, or the like. In addition, in certain cases, there may be terms chosen arbitrarily by the applicant, and in this case, a meaning thereof will be described in detail in the description of the present invention. Therefore, the term used in the present invention should be defined on the basis of the meaning of the term and the entire contents of the present invention, not on the simple name of the term.

When an element is referred to as “including” a component throughout the specification, it is to be understood that the component may include other components as well unless specifically stated otherwise. In addition, the terms “part”, “module”, and the like described in the specification mean units for processing at least one function or operation, which may be implemented in hardware, software, or a combination of hardware and software.

Hereinafter, embodiments of the present invention will be described in detail with reference to the accompanying drawings. However, the following illustrative embodiments of the present invention may be modified into various other forms, and the scope of the present invention is not limited to the embodiments described below. The embodiments of the present invention are provided to enable those skilled in the art to more fully understand the present invention.

Combinations of each block and step of the accompanying block diagrams and flowcharts, respectively, may be performed by computer program instructions (execution engines). Because computer program instructions may be loaded into a general-purpose computer, special purpose computer, or other processor of a programmable data processing apparatus, the instructions that are executed through the processor of the computer or other programmable data processing equipment generate means for performing the functions described in each block of the block diagram or each step of the flowchart. Because these computer program instructions may also be stored in a computer usable or computer readable memory capable of directing a computer or other programmable data processing apparatus to implement the functionality in a particular manner, it is also possible that the instructions stored in the computer usable or computer readable memory may produce a manufacturing article containing instruction means for performing the functions described in each block of the block diagram or each step of the flowchart.

Because computer program instructions may also be loaded into a computer or other programmable data processing equipment, a series of operating steps may be performed on a computer or other programmable data processing equipment to create a computer-implemented process, whereby the instructions that control a computer or other programmable data processing equipment may be capable of providing the steps for executing the functions described in each block of the block diagram and at each step of the flowchart.

In addition, each block or step may represent a module, a segment, or a portion of a code that includes at least one executable instructions for executing the specified logical functions. Here, it should be noted that in several alternative embodiments, the functions mentioned in the blocks or steps may occur out of sequence. For example, it is also possible that the two blocks or steps shown one after the other are actually carried out substantially simultaneously, and it is also possible that the blocks or steps are performed in a reverse order of the corresponding functions as required.

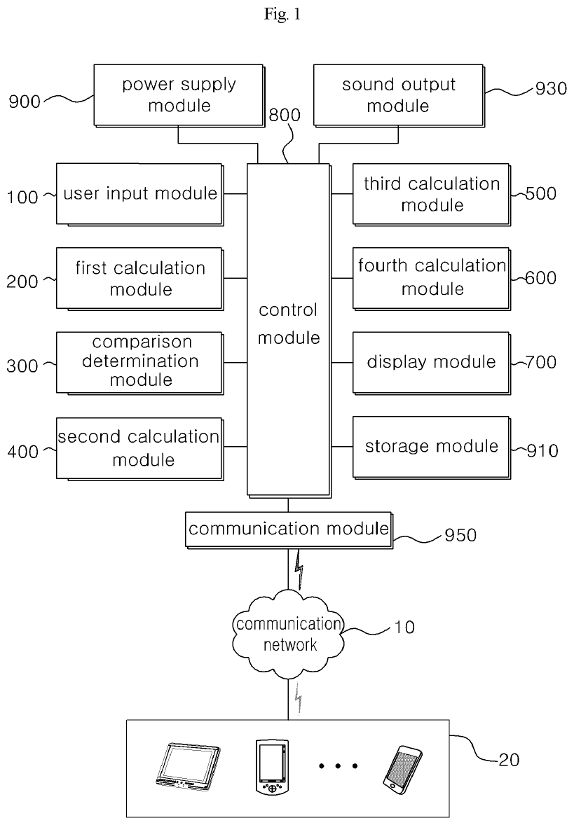

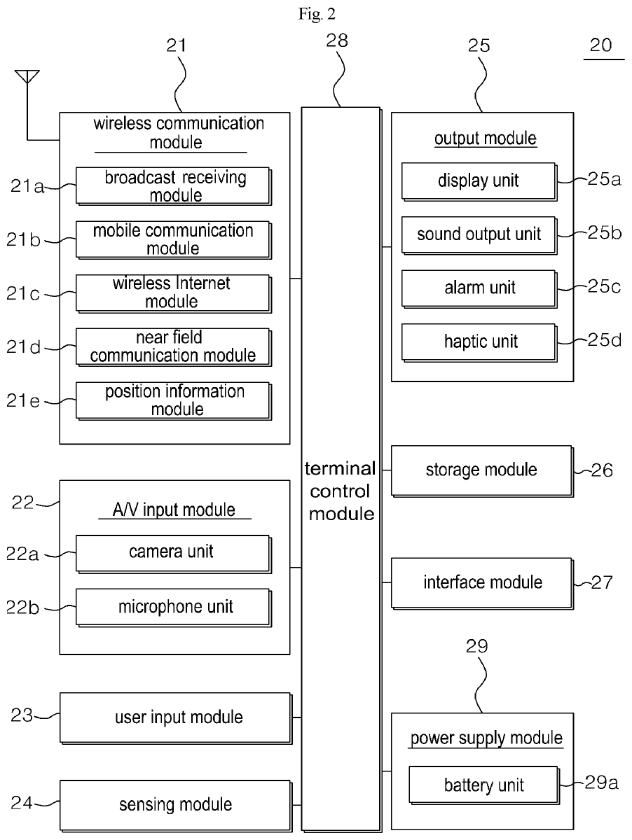

FIG. 1 is an overall block diagram illustrating an apparatus for analyzing sloshing behavior of a fluid contained in a water pool according to the embodiment of the present invention, and FIG. 2 is a detailed block diagram illustrating a user terminal applied to the embodiment of the present invention;

With reference to FIGS. 1 and 2, the apparatus for analyzing sloshing behavior of the fluid contained in the water pool according to the embodiment of the present invention includes a user input module 100, a first calculation module 200, a comparison determination module 300, a second calculation module 400, a third calculation module 500, a fourth calculation module 600, a display module 700, a control module 800, a power supply module 900, and the like. In addition, the apparatus for analyzing sloshing behavior of the fluid contained in the water pool according to the embodiment of the present invention may further include a storage module 910, a sound output module 930, a communication module 950, and the like. Meanwhile, it should be noted that the components shown in FIGS. 1 and 2 are not indispensable, so that the apparatus for analyzing sloshing behavior of the fluid contained in the water pool according to the embodiment of the present invention may have more or fewer components than the components shown in FIGS. 1 and 2.

Hereinafter, the components of the apparatus for analyzing sloshing behavior of the fluid contained in the water pool according to the embodiment of the present invention will be described in detail as follows.

The user input module 100 is a module that performs a function of outputting a specific input signal of a corresponding user according to a request of a user or an operation of the user, and may be typically composed of a mouse and/or a keyboard, and the like, but the present invention may not be limited thereto. In some cases, the user input module 100 may be composed of a remote controller, a touch screen, or the like.

For example, a resistance film type, a capacitive type, an infrared type, an ultrasonic type, or the like may be applied as the touch screen, and, for a minimization of the thickness, a capacitive type may be most appropriately applied.

The capacitive touch screen may be composed of indium tin oxide (ITO), a structure of which is typically made of a conductive transparent plate, an electrode part provided by painting a silver paint on a rim of the ITO, and an insulation coating part insulating a lower portion of the electrode part. Meanwhile, the ITO may be composed of an ITO film made of a light transmitting resin and an ITO coating layer on which a conductive material is coated on a bottom portion of the ITO film.

When the top surface of the ITO is touched by finger, the capacitance varies through the finger so that the capacitive touch screen as described above may detect the touch position according to capacitance variation, which is sensed by each electrode provided on four sides thereof.

The first calculation module 200 receives information data on a width of the water pool, a height of the fluid contained in the water pool, and a width and cycle of an external excitation, output according to the specific input signal of the corresponding user from the user input module 100 and then, on a basis thereof, performs a function of calculating a natural frequency of an nth (n=1, 2, 3, . . . ) mode the fluid according to the free surface movement of the fluid as well as a frequency of the external excitation.

At this time, the fluid may be, for example, composed of cooling water for cooling a nuclear fuel assembly used for nuclear power generation.

In addition, the water pool may be composed of a spent nuclear fuel storage pool cooling and storing the nuclear fuel assembly used for nuclear power generation in the cooling water, for example.

The comparison determination module 300 compares a value of the frequency of the external excitation with a value of the natural frequency of the nth mode of the fluid calculated from the first calculation module 200, thereby performing a function of determining whether the frequency of the external excitation is greater than twice the natural frequency of a primary mode of the fluid contained in the water pool.

When the frequency of the external excitation is determined to be greater than twice the natural frequency of the primary mode of the fluid contained in the water pool by the comparison determination module 300, the second calculation module 400 performs a function of calculating a height change value of the fluid due to the frequency of the external excitation using the values of the frequency of the external excitation and the natural frequency of the nth mode of the fluid, calculated from the first calculation module 200 along with the information data, on the width of the water pool, the height of the fluid contained in the water pool, and the width and frequency of the external excitation, output according to the specific input signal of the corresponding user from the user input module 100.

When the frequency of the external excitation is determined to be greater than twice the natural frequency of the primary mode of the fluid contained in the water pool by the comparison determination module 300, the third calculation module 500 performs a function of calculating a height change value of the fluid due to convection of the fluid contained in the water pool using the values of the frequency of the external excitation and the natural frequency of the nth mode of the fluid, calculated from the first calculation module 200 along with the information data, on the width of the water pool, the height of the fluid contained in the water pool, and the width and frequency of the external excitation, output according to the specific input signal of the corresponding user from the user input module 100.

The fourth calculation module 600 performs a function of summing the height change value of the fluid due to the frequency of the external excitation calculated from the second calculation module 400 and the height change value of the fluid due to the convection of the fluid contained in the water pool calculated from the third calculation module 500, thereby calculating a sloshing value of the fluid contained in the water pool.

The display module 700 performs a function of displaying on a display screen information on a sloshing behavior analysis of the fluid contained in the water pool on the basis of the sloshing value of the fluid contained in the water pool calculated from the fourth calculation module 600.

The display module 700 may include, for example, at least one of a liquid crystal display (LCD), a light-emitting diode (LED), a thin film transistor-liquid crystal display (TFT LCD), an organic light-emitting diode (OLED), a flexible display, a plasma display panel (PDP), an alternate lighting of surfaces (ALiS), a digital light processing (DLP), a liquid crystal on silicon (LCoS), a surface-conduction electron-emitter display (SED), a field emission display (FED), a laser TV (quantum dot laser and liquid crystal laser), ferroelectric liquid crystal (FLD), an interferometric modulator display (iMoD), a thick-film dielectric electroluminescent (TDEL), a quantum dot display (QD-LED), a telescopic pixel display (TPD), an organic light-emitting transistor (OLET), a laser fluorescent display (LFD), and a three-dimensional display (3D display), but is not limited thereto. In other words, the display module 700 may include any display as far as it is capable of displaying numbers, letters, figures, and the like.

The control module 800 performs overall control of the apparatus for analyzing sloshing behavior of the fluid contained in the water pool according to the embodiment of the present invention. In particular, the control module 800 receives the sloshing value, calculated from the fourth calculation module 600 according to the specific input signal of the corresponding user from the user input module 100, of the fluid contained in the water pool and, on the basis thereof, generates information on the sloshing behavior analysis of the fluid contained in the water pool, thereby performing a function of controlling operations of the user input module 100, the first calculation module 200, the comparison determination module 300, the second calculation module 400, the third calculation module 500, the fourth calculation module 600, and the display module 700 to allow the same to be displayed in a form of a text and/or graph on a display screen of the display module to be visually seen by the corresponding user.

In addition, the control module 800 may perform a function of converting graph type information into an image file, thereby controlling the image file to be stored in a separate storage module 910.

Various embodiments described herein may be implemented within a recording medium readable by a computer or similar device using, for example, software, hardware, or a combination thereof.

According to a hardware-wise implementation, the embodiments described herein may be implemented using at least one of application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, and electrical units for performing functions. In some cases, such embodiments may be implemented by the control module 800.

According to a software-wise implementation, embodiments such as procedures or functions may be implemented along with separate software modules that allow at least one function or operation to be performed. A software code may be implemented by a software application written in a suitable programming language. In addition, the software code may be stored in storage means (for example, the storage module 910 and the like) and executed by the control module 800.

The power supply module 900 performs a function of supplying power necessary for each above-described module, that is, the user input module 100, the first calculation module 200, the comparison determination module 300, the second calculation module 400, the third calculation module 500, the fourth calculation module 600, the display module 700, the control module 800, the storage module 910, the sound output module 930, the communication module 950, and the like.

Here, the power supply module 900 may be preferably used, for continuous power supply, by converting a commercial AC power source (for example, AC 220 V) to a DC power source, but the present invention is not limited thereto, and a separate battery may be used.

In addition, the power supply module 900 may include a power management unit (not shown) performing a function of protecting the components from an external power shock and outputting a constant voltage. The power management unit may include an electrostatic damage (ESD) protector, a power detector, a rectifier, a power breaker, and the like.

Here, the ESD protector is configured to protect electrical components from static electricity or abrupt power shock. The power detector is configured to send a shutoff signal to the power breaker when a voltage out of an allowable voltage range is input and to transmit a step-up or step-down signal to the rectifier in accordance with the voltage change within the allowable voltage range. The rectifier is configured to perform the step-up or step-down rectification operation in accordance with the signal of the power detector, thereby minimizing a variation of the input voltage so that a constant voltage is supplied. The power breaker is configured to shut off the power supplied from the battery in accordance with the shutoff signal transmitted from the power detector.

In addition, the storage module 910 performs, according to a control of the control module 800, a function of establishing a database (DB) for at least a piece of information among pieces of information on the natural frequency of the nth mode of the fluid according to the free surface movement of the fluid calculated from the first computation module 200, the height change value of the fluid due to the frequency of the external excitation calculated from the second calculation module 400, the height change value of the fluid due to the convection of the fluid contained in the water pool calculated from the third calculation module 500, the sloshing value of the fluid contained in the water pool calculated from the fourth calculation module 600, and/or the sloshing behavior analysis of the fluid contained in the water pool, thereby storing the same.

The storage module 910 may include a storage medium of at least one type of a flash memory type, a hard disk type, a multimedia card micro type, a card type memory (for example, an SD memory, an XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

Further, the sound output module 930 performs, according to the control of the control module 800, a function of outputting the information on the sloshing behavior analysis of the fluid contained in the water pool by a sound to allow the sound to be acoustically heard by the user.

The sound output module 930 may also be preferably implemented with a conventional speaker but is not limited thereto. The sound output module 930 may be implemented with a connection jack or the like including an audio amplification circuit to allow the user to listen through an earphone or a headphone.

In addition, the communication module 950 performs, according to a control of the control module 800, a function of transmitting at least a piece of information among pieces of information on the natural frequency of the nth mode of the fluid according to the free surface movement of the fluid calculated from the first computation module 200, the height change value of the fluid due to the frequency of the external excitation calculated from the second calculation module 400, the height change value of the fluid due to the convection of the fluid contained in the water pool calculated from the third calculation module 500, the sloshing value of the fluid contained in the water pool calculated from the fourth calculation module 600, and/or the sloshing behavior analysis of the fluid contained in the water pool to an external user terminal 20 through a communication network 10.

At this time, the communication network 10 may be, for example, composed of a near field communication (for example, a Bluetooth communication, a ZigBee communication, an ultra wideband (UWB) communication, a radio frequency identification (RFID) communication, an infrared (IR) communication, or the like), an Ethernet communication network, a mobile communication network, or the like. In addition, the communication network 10 may be a communication network that is a high-speed backbone network of a large scale communication network capable of providing a large capacity and long distance sound and data services, or may be a next generation wireless network that includes a WiFi, a WiBro, a WiMAX, and the like to provide an internet or a high-speed multimedia service.

The Internet refers to a worldwide open computer network architecture that provides various services existed in a TCP/IP protocol and an upper layer thereof, that is, a hyper text transfer protocol (HTTP), a telnet, a file transfer protocol (FTP), a domain name system (DNS), a simple mail transfer protocol (SMTP), a simple network management protocol (SNMP), a network file service (NFS), a network information service (NIS), and the like. In addition, the Internet provides an environment in which the user terminal 20 may be connected to the communication module 950. Meanwhile, the Internet may be a wired or wireless Internet, or, in addition to the above, may be a core network integrated with a wired public network, a wireless mobile communication network, a portable Internet, or the like.

When the communication network 10 is a mobile communication network, the communication network 10 may be a synchronous mobile communication network or an asynchronous mobile communication network. An example of the asynchronous mobile communication network may be a wideband code division multiple access (WCDMA) communication network. In this case, although not shown in the drawings, the mobile communication network may include, for example, a radio network controller (RNC) and the like. Meanwhile, although the WCDMA network is referred to as an example, the asynchronous mobile communication network may be a next generation communication network such as a 3G LTE network, a 4G network, a 5G network, and the like or an IP network based on other IPs. The communication network 10 as above performs a role of mutually transferring signals and data between the user terminal 20 and the communication module 950.

In addition, the external user terminal 20 may perform a function of receiving at least a piece of information among pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and/or the sloshing behavior analysis of the fluid contained in the water pool, transmitted from the communication module 950 through an application service previously installed and related to the sloshing behavior analysis of the fluid, thereby, on the basis of the same, displaying in the form of the text and/or the graph on the display screen of the corresponding user terminal the same to be visually seen by the corresponding user.

Meanwhile, the user terminal 20 applied to the embodiment of the present invention may be preferably composed of a mobile terminal device of at least any one of a smartphone, a smart pad, and a smart note, which communicate through a wireless Internet or a portable Internet. In addition to the above, the user terminal 20 may comprehensively refer to all wired and wireless home appliances/communication devices such as a personal PC, a notebook PC, a palm PC, a mobile play-station, a digital multimedia broadcasting (DMB) phone having a communication function, a tablet PC, an iPad, and the like, which have user interfaces connecting the communication module 950 thereto.

As shown in FIG. 2, the user terminal 20 may include a wireless communication module 21, an audio/video (A/V) input module 22, a user input module 23, a sensing module 24, an output module 25, a storage module 26, an interface module 27, a terminal control module 28, a power supply module 29, and the like. Meanwhile, because the components shown in FIG. 2 are not indispensable, the user terminal 20 may have more or fewer components than the components shown in FIG. 2.

Hereinafter, the components of the user terminal 20 will be described in detail.

The wireless communication module 21 may include at least one module that enables wireless communication to be possible between the user terminal 20 and the communication module 950. For example, the wireless communication module 21 may include a broadcast receiving module 21a, a mobile communication module 21b, a wireless Internet module 21c, a near field communication module 21d, a position information module 21e, and the like.

The broadcast receiving module 21a receives broadcast signals (for example, a TV broadcast signal, a radio broadcast signal, a data broadcast signal, and the like) and/or broadcast-related information from an external broadcast management server through various broadcast channels (for example, a satellite channel, a terrestrial channel, and the like).

The mobile communication module 21b transmits and receives a wireless signal to and from at least one of a base station, an external terminal, and a server on a mobile communication network. The wireless signal may include various types of data according to a sound call signal, a video call signal, or a text/multimedia message transmission and reception.

The wireless Internet module 21c is a module for wireless Internet access and may be built in or externally attached to the user terminal 20. As technologies related to the wireless Internet, for example, WLAN (Wi-Fi), Wibro, Wimax, HSDPA, LTE, and the like may be used.

The near field communication module 21d is a module for short-range communication such as the Bluetooth communication, the ZigBee communication, the UWB communication, the RFID communication, the IR communication, or the like.

The position information module 21e is a module for confirming or obtaining a position of the user terminal 20 and may acquire current position information of the user terminal 20 using a global position system (GPS) or the like.

Meanwhile, the data transmission and reception with the communication module 950 may be performed, according to a control of the terminal control module 28, using the specific application program stored in the storage module 26 via the wireless communication module 21 and/or the wired communication module (not shown).

The A/V input module 22 is a module for inputting an audio signal or a video signal and may fundamentally include a camera unit 22a and a microphone unit 22b. The camera unit 22a processes an image frame such as a still image, a moving image, or the like obtained by the image sensor in a video communication or a photographing mode. The microphone unit 22b receives an external audio signal by a microphone in a communication mode, a recording mode, a sound recognition mode, or the like and processes the same into electrical audio data.

The user input module 23 is a module for generating input data for controlling the operation of the user terminal 20 and, in particular, performs a function of inputting a selection signal for any one of pieces of information on the sloshing behavior analysis of the fluid displayed through a display unit 25a of the output module 25. For example, the user input module 23 may be input using a touch panel (static pressure/capacitance) type input by touch of the user or a separate input device (for example, a keypad dome switch, a jog wheel, a jog switch, and the like).

The sensing module 24 senses a current state of the user terminal 20 such as an opening and closing state of the user terminal 20, a position of the user terminal 20, presence/nonpresence of the touch of the user, a touch operation of the user with respect to a specific part, bearing of the user terminal 20, an acceleration/deceleration of the user terminal 20, and the like and generates a sensing signal for controlling the operation of the user terminal 20. The above sensing signal is transmitted to the terminal control module 28, and may become a basis on which the terminal control module 28 performs a specific function.

The output module 25 is a module for generating an output related to visual, auditory, or tactile sense and fundamentally includes the display unit 25a, a sound output unit 25b, an alarm unit 25c, a haptic unit 25d, and the like.

The display unit 25a is for display-outputting information processed in the user terminal 20. For example, the display unit 25a displays a user interface (UI) or a graphical user interface (GUI) when the user terminal 20 is in the communication mode and displays photographed and/or received image or the UI and the GUI when the mode is in the video communication mode or the photographing mode.

The sound output unit 25b may also output audio data that is received from the wireless communication module 21 in, for example, a call signal reception, the communication or recording mode, the sound recognition mode, a broadcast reception mode, and the like or that is stored in the storage module 26.

The alarm unit 25c may output a signal for notifying an occurrence of an event in the user terminal 20. Examples of the event occurred in the user terminal 20 include call signal reception, message reception, a key signal input, a touch input, and the like.

The haptic unit 25d generates various tactile effects that the user may feel. A typical example of haptic effects generated by the haptic unit 25d is vibration. An intensity and a pattern of the vibration generated by the haptic unit 25d may be controlled.

The storage module 26 may store a program for the operation of the terminal control module 28 and temporarily store data (for example, a phone book, a message, a still image, a moving image, and the like) that is input/output.

In addition, the storage module 26 may store data related to vibrations and sounds of various patterns that are output when the touch input is given on the touch screen and may store application programs related to the sloshing behavior analysis of the fluid.

In addition, because the storage module 26 may store source data for the formation of information related to the sloshing behavior analysis of the fluid, the data related to the sloshing behavior analysis of the fluid of the communication module 950 may be provided in a form composed of the image and sound, and the processes and results of the production progress of the information data related to the sloshing behavior analysis of the fluid of the control module 800 may also be stored together.

The above storage module 26 may include at least one type of the flash memory type, the hard disk type, the multimedia card micro type, the card type memory (for example, the SD memory, the XD memory, or the like), the RAM, the SRAM, the ROM, the EEPROM, the PROM, the magnetic memory, the magnetic disk, and the optical disk.

The interface module 27 serves as a path for communication with all the external devices connected to the user terminal 20. The interface module 27 receives data from an external device and transfers the data to each component in the user terminal 20 or allows data in the user terminal 20 to be transmitted to the external device.

The terminal control module 28 typically controls the overall operation of the user terminal 20 and performs related controls and processing for, for example, sound calls, data communication, video calls, and execution of various applications.

That is, the terminal control module 28 controls execution of the application program, related to the sloshing behavior analysis of the fluid stored in the storage module 26, to be performed, requests a generation of the data, related to the sloshing behavior analysis of the fluid, through the execution of the application program related to the sloshing behavior analysis of the fluid, and performs a function of controlling to allow the information data, related to the sloshing behavior analysis of the fluid generated as requested, to be provided.

In addition, in the process of generating information data related to the sloshing behavior analysis of the fluid desired by the user, the terminal control module 28 performs, through the execution of the application program related to the sloshing behavior analysis of the fluid, a function of controlling to allow auxiliary components, which include at least one of image and, voice or sound, to be output through at least one of the display unit 25a and other output devices (for example, the sound output unit 25b, the alarm unit 25c, the haptic unit 25d, and the like).

In addition, the terminal control module 28 may regularly monitor a charging current and a charging voltage of a battery unit 29a and temporarily store a monitoring value in the storage module 26. At this time, the storage module 26 may store not only battery charging status information such as the monitored charging current and the charging voltage, but also battery specification information (product code, rating, and the like).

Applied with external power and internal power by the control of the terminal control module 28, the power supply module 29 supplies the power necessary for the operation of the respective components. The power module 29 supplies the power source of the built-in battery unit 29a to the respective components, thereby allowing the respective components to operate, and the battery may be charged using charging terminals (not shown).

Various embodiments described herein may be implemented in a recording medium readable by a computer or similar device using, for example, software, hardware, or a combination thereof.

According to a hardware-wise implementation, the embodiments described herein may be implemented using at least one of application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, and electrical units for performing functions. In some cases, such embodiments may be implemented by the terminal control module 28.

According to a software-wise implementation, embodiments such as procedures or functions may be implemented along with separate software modules that allow at least one function or operation to be performed. A software code may be implemented by a software application written in a suitable programming language. In addition, the software code may be stored in the storage module 26 and executed by the terminal control module 28.

Meanwhile, when the user terminal 20 is composed of a smartphone, unlike a general mobile phone (also known as a feature phone), the smartphone is a phone based on an open operating system that allows a user to download various desired application programs and to freely use and delete the application programs as the user wants. Accordingly, the smartphone may be understood as a communication device that includes all mobile phones, not only having a function such as a sound/image call, Internet data communication, and the like, which are generally used, but also having mobile office function, as well as all Internet phones or tablet PCs, having no sound call function but accessible to Internet.

Such a smartphone may be implemented with a smartphone equipped with various open operating systems. Examples of the open operating system include Symbian of Nokia, e BlackBerry of RIMS, iOS of Apple, Windows Mobile of Microsoft, Android of Google, Bada of Samsung Electronics, and the like.

As such, because the smartphone uses an open operating system, a user may arbitrarily install and manage various application programs, unlike a mobile phone having a closed operating system.

That is, the forementioned smartphone fundamentally includes a control unit, a memory unit, a screen output unit, a key input unit, a sound output unit, a sound input unit, a camera unit, a wireless network communication module, a near field wireless communication module, and a battery for power supply.

The control unit is a generic term for a functional configuration for controlling the operation of the smartphone, includes at least one processor and an execution memory, and is connected to each functional unit provided in the smartphone through a bus.

The control unit as above loads at least one program code provided in the smartphone into the execution memory through the processor, thereby performing a calculation, and then transfers a calculation result to at least one functional unit through the bus, thereby controlling the operation of the smartphone.

The memory unit fundamentally stores a system program code and a system data set corresponding to an operating system of a smartphone, a communication program code and a communication data set for processing a wireless communication connection of the smartphone, and at least one application program code and an application data set. In addition, the program code and data set for implementing the present invention are also stored in the memory unit.

The screen output unit is composed of a screen output device (for example, a liquid crystal display (LCD) device) and an output module driving the same. Here, the screen output unit is connected to the control unit with a bus, thereby outputting calculation results corresponding to the screen output among various calculation results of the control unit by the screen output device.

The key input unit is composed of a key input device (or a touch screen device interlocked with the screen output unit) having at least one key button and an input module driving the same. Here, the key input unit is connected to the control unit with a bus, thereby inputting a command commanding various calculations of the control unit or inputting data necessary for the calculations of the control unit.

The sound output unit is composed of a speaker outputting a sound signal and a sound module driving the same. Here, the sound output unit is connected to the control unit with a bus, thereby outputting calculation results corresponding to the sound output among various calculation results of the control unit through the speaker. Meanwhile, the sound module decodes sound data to be output through the speaker, thereby converting the sound data into a sound signal.

The sound input unit is composed of a microphone receiving a sound signal and a sound module driving the same and transfers the sound data input through the microphone to the control unit. The sound module encodes a sound signal input through the microphone, thereby encoding the sound signal.

The camera unit is composed of an optical unit and, a charge coupled device (CCD) and a camera module driving the same, and obtains bitmap data input to the CCD through the optical unit. Here, the bitmap data may include both still image data and moving image data.

The wireless network communication module is a generic term for a communication configuration for connecting wireless communication and includes at least one of an antenna for transmitting and receiving a wireless frequency signal of a specific frequency band, a RF module, a baseband module, and a signal processing module. Here, the wireless network communication module is connected to the control unit with a bus, thereby transmitting calculation results corresponding to the wireless communication among various calculation results of the control unit through the wireless communication or receiving data through the wireless communication, thereby transferring the data to the control unit and, at the same time, maintaining connection, registration, communication, and handoff procedures of the wireless communication.

In addition, the wireless network communication module includes a mobile communication configuration performing, to a mobile communication network, according to a CDMA/WCDMA standard, at least one of a connection, a position registration, a call processing, a call connection, a data communication, and a handoff. Meanwhile, according to an intention of those skilled in the art, the wireless network communication module may further include a portable Internet communication configuration performing, to the portable Internet according to the IEEE 802.16 standard, at least one of a connection, a position registration, a data communication, and a handoff. In addition, it is obviously noted that the present invention is not limited by the wireless communication configuration provided by the wireless network communication module.

The near field wireless communication module is composed of a near field wireless communication module connecting a communication session using a wireless frequency signal as a communication medium within a predetermined distance and may include a RFID communication, a Bluetooth communication, a Wi-Fi communication, and a public wireless communication, of ISO 180000 series standard. In addition, the near field wireless communication module may be integrated with the wireless network communication module.

The smartphone configured as above refers to a terminal capable of wireless communication, and any device capable of transmitting and receiving data through a network including the Internet may be applicable as well as a smartphone. That is, the smartphone may include at least one of a notebook PC, a tablet PC, and, additionally, a terminal capable of carrying and moving, all of which have a short message transmission function and a network connection function.

Hereinafter, a method of analyzing sloshing behavior of a fluid contained in a water pool according to an embodiment of the present invention will be described in detail.

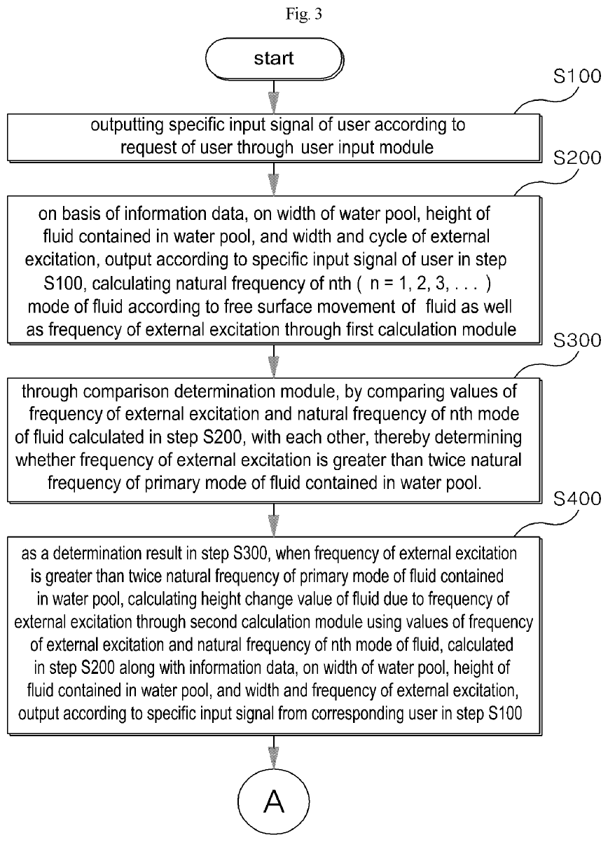

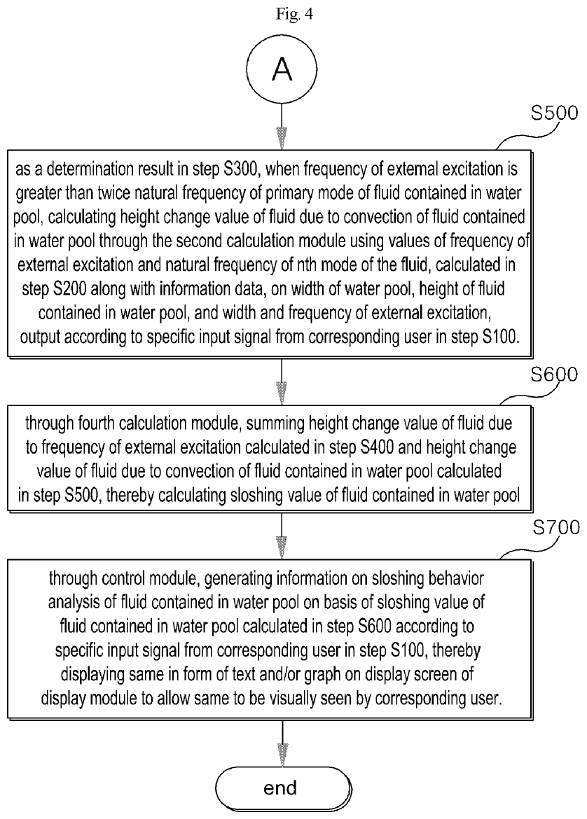

FIGS. 3 and 4 are overall flowcharts explaining the method of analyzing sloshing behavior of the fluid contained in the water pool according to the embodiment of the present invention.

With reference to FIGS. 1 to 4, in S100, the method of analyzing a sloshing behavior analysis of the fluid contained in the water pool according to the embodiment of the present invention, first, outputs a specific input signal of a user according to a request of the user through the user input module 100.

Then, in S200, on a basis of information data, on a width of the water pool, a height of the fluid contained in the water pool, and a width and cycle of the external excitation, output according to the specific input signal of the user in step S100, a natural frequency of the nth (n=1, 2, 3, . . . ) mode of the fluid according to a free surface movement of the fluid as well as a frequency of the external excitation is calculated through the first calculation module 200.

At this time, in step S200, the fluid may be, for example, composed of cooling water for cooling a nuclear fuel assembly used for nuclear power generation.

In addition, in step S200, the water pool may be composed of a spent nuclear fuel storage pool cooling and storing the nuclear fuel assembly used for the nuclear power generation in the cooling water, for example.

Then, in S300, by comparing values of the frequency of the external excitation and the natural frequency of the nth mode of the fluid calculated in step S200 with each other, it is determined whether the frequency of the external excitation is greater than twice the natural frequency of a primary mode of the fluid contained in the water pool through the comparison determination module 300.

Then, in S400, as a determination result in step S300, when the frequency of the external excitation is greater than twice the natural frequency of the primary mode of the fluid contained in the water pool, a height change value of the fluid due to the frequency of the external excitation is calculated through the second calculation module 400 using the values of the frequency of the external excitation and the natural frequency of the nth mode of the fluid, calculated in step S200 along with the information data, on the width of the water pool, the height of the fluid contained in the water pool, and the width and frequency of the external excitation, output according to the specific input signal of the corresponding user in step S100.

Subsequently, in S500, as a determination result in step S300, when the frequency of the external excitation is greater than twice the natural frequency of the primary mode of the fluid contained in the water pool, a height change value of the fluid due to convection of the fluid contained in the water pool is calculated through the third calculation module 500 using the values of the frequency of the external excitation and the natural frequency of the nth mode of the fluid, calculated in step S200 along with the information data, on the width of the water pool, the height of the fluid contained in the water pool, and the width and frequency of the external excitation, output according to the specific input signal of the corresponding user in step S100.

Then, in S600, through the fourth calculation module 600, by summing the height change value of the fluid due to the frequency of the external excitation calculated from the second calculation in step S400 and the height change value of the fluid due to the convection of the fluid contained in the water pool calculated in step S500, a sloshing value of the fluid contained in the water pool is calculated.

Then, in S700, through the control module 800, information on the sloshing behavior analysis of the fluid contained in the water pool is generated on the basis of the sloshing value of the fluid contained in the water pool calculated in step S600 according to the specific input signal of the corresponding user in step S100, and is displayed in a form of a text and/or a graph on a display screen of the display module 700 to allow the same to be visually seen by the corresponding user.

Additionally, although not shown in the drawings, after step S700, through the control module 800, a first step may be further included, the first step establishing a database (DB) for at least a piece of information among pieces of information on the natural frequency of the nth mode of the fluid according to the free surface movement of the fluid calculated in step S200, the height change value of the fluid due to the frequency of the external excitation calculated in step S400, the height change value of the fluid due to the convection of the fluid contained in the water pool calculated in step S500, the sloshing value of the fluid contained in the water pool calculated in the step S600, and/or the sloshing behavior analysis of the fluid contained in the water pool, thereby storing the same in a separate storage module 910.

Further, after step S700 or the first step, through the control module 800, a second step may be further included, the second step allowing at least a piece of information among pieces of information on the natural frequency of the nth mode of the fluid according to the free surface movement of the fluid calculated in step S200, the height change value of the fluid due to the frequency of the external excitation calculated in step S400, the height change value of the fluid due to the convection of the fluid contained in the water pool calculated in step 5500, the sloshing value of the fluid contained in the water pool calculated in the step 5600, and/or the sloshing behavior analysis of the fluid contained in the water pool to be transferred to a separate communication module 950 so as to be transmitted to an external user terminal 20.

Further, a third step may be further included to allow information to be displayed in a form of a text and/or a graph on a display screen of the corresponding user terminal 20 to be visually seen by the corresponding user, on the basis of at least a piece of the information among pieces of the information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and/or the sloshing behavior analysis of the fluid contained in the water pool, transmitted from the communication module 950 through an application service related to the sloshing behavior analysis of the fluid installed in the external user terminal 20.

In addition, after step 5700 or any one of the first to third steps, through the control module 800, a fourth step may be further included to allow the information on the sloshing behavior analysis of the fluid contained in the water pool to be transmitted to a separate sound output module 930 outputting the same by a sound so as be acoustically heard by the user.

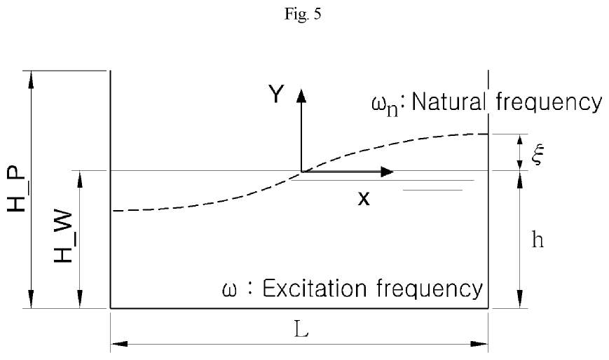

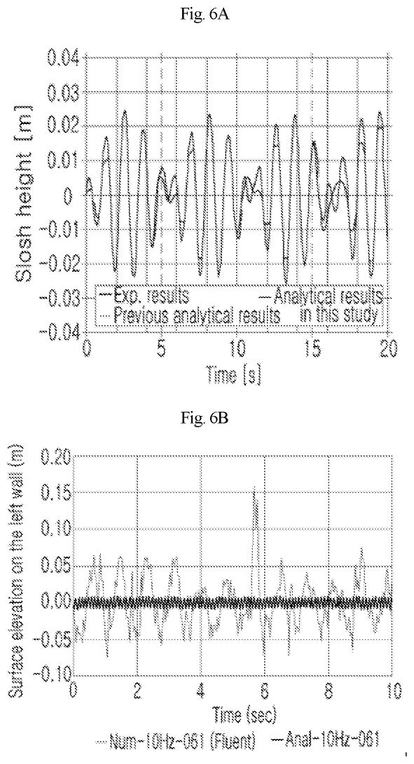

FIG. 5 is a conceptual view of the water pool explaining a calculation of sloshing of the fluid contained in the water pool in the method of analyzing the sloshing behavior of the fluid contained in the water pool according to the embodiment of the present invention, and FIGS. 6 to 14 are graphs of simulation results comparing the method of analyzing the sloshing behavior of the fluid contained in the water pool according to the embodiment of the present invention and a method of a conventional analysis.

With reference to FIGS. 5 to 14, first, a description will be given to a linear theory that is a basis on the method of analyzing the sloshing behavior of the fluid contained in the water pool according to the embodiment of the present invention.

The linear theory is a linear approximation equation for analyzing a behavior of a fluid (see FIG. 5) contained in a rectangular water pool and is a theory introduced by Norwegian mathematician Odd Magnus Faltinsen (Norwegian University of Science and Technology)

An analytical result of a change of a free surface of the fluid to an external excitation using the linear theory has been reported to be very similar to the behavior of the fluid determined through experiments although the nonlinear behavior characteristic such as viscosity of the fluid is not reflected.

As a result of the analysis of the present invention, it was possible to check that, for the external excitation of low frequencies, the change of the free surface of the fluid obtained using the linear theory was very similar to that obtained using the CFD analysis.

However, for the external excitation of high frequencies, it was confirmed that the result obtained using the linear theory was substantially different from that obtained using the CFD analysis. Therefore, the current linear theory has a limitation to be applicable only to the external excitation of low frequencies.

The linear theory is an equation designed on the basis of the following governing equation.

∇²Ø=0 (equation 1)

where, Φ is velocity potential. In addition, a fixed boundary condition of the water pool is given as equation 2 below.

$$\begin{matrix}\frac{\partial φ}{\partial x} = 0 , & x = \pm L \text{/} 2 \\ \frac{\partial φ}{\partial y} = 0 , & z = - h\end{matrix} \qquad ( equation 2 )$$

where L is the width of the water pool, and h is the height of the fluid contained in the water pool. In addition, the fixed boundary condition for the free surface at a position y=ξ is given by equation 3 below.

$$\frac{\partial φ}{\partial t} = \frac{\partial φ}{\partial z} \frac{\partial ξ}{\partial t} - g ξ - \frac{1}{2} ( ∇ φ \times ∇ φ ) - x \ddot{X ( t )} \qquad ( equation 3 )$$

In addition, a kinematic boundary condition of the free surface may be expressed as equation 4 below.

$$\frac{\partial ξ}{\partial t} = \frac{\partial φ}{\partial z} - \frac{\partial φ}{\partial x} \frac{\partial ξ}{\partial x} \qquad ( equation 4 )$$

The equations expressed as above are nonlinear problems that are difficult to calculate analytically. The free surface condition is added to the free surface of the actual position y=ξ by excluding the nonlinear equations. At this time, because the height of the actual free surface is also unknown, the height of the free surface, one of the major nonlinear components, is to be calculated together.

For this reason, there need to be two assumptions in the linearized equation. As a first assumption, the boundary condition of the free surface is added to y=0, which is the original position of the free surface. As a second assumption, the quadratic differential term, the nonlinear component of equations 3 and 4 above, is neglected.

Accordingly, the solution obtained through the linearized equations has some limitations as follows. First, the water depth should not be low. Second, the calculated breaking wave in the sloshing of the water may not be included. Third, the sloshing of the water is to be at a moderate level, and the fluid is not to hit the ceiling or fall over the tank wall. Fourth, the walls of the water pool (or tank) are to be vertical.

In addition, linear solutions devised by Faltinsen with respect to FIG. 5 are expressed as equations 5 to 13 below. The velocity potential may be calculated according to equation 5, and the calculated velocity potential is used to calculate a pressure of the fluid according to equation 6.

$$\begin{matrix}φ ( x , y , t ) = A {\sum }_{n = 0}^{∞} ( ( {C}_{n} cos ( ω t ) - ( {C}_{n} + \frac{{H}_{n}}{{ω}^{2}} ) cos ( ω t ) ) \frac{cosh ( {k}_{n} ( y + h ) )}{cosh ( {k}_{n} h )} sin ( {k}_{n} x ) & ( equation 5 ) \\ p = - ρ ( \frac{\partial φ}{\partial t} + x \frac{d \dot{X}}{d t} ) & ( equation 6 )\end{matrix}$$

Where, A is an amplitude of the external excitation and n (0, 1, 2, 3, . . . ) is a number referring to a natural mode of the fluid.

In addition, the height at an arbitrary horizontal position on the free surface may be calculated by equation 7 below, wherein equation 7 consists of two components, ξ₁ and ξ₂. The first component ξ₁ is a height variation component due to a frequency w of the external excitation and is calculated by equation 8 below. The second component ξ₂ is a height variation component due to convection of the fluid contained in the water pool, and is calculated by equation 9 below.

$$\begin{matrix}ξ ( x , t ) = {ξ}_{1} ( x , t ) + {ξ}_{2} ( x , t ) & ( equation 7 ) \\ {ξ}_{1} ( x , t ) = \frac{A}{g} ( x {ω}^{2} + {\sum }_{n = 0}^{∞} {C}_{n} ω sin ( {k}_{n} x ) ) sin ( ωt ) & ( equation 8 ) \\ {ξ}_{2} ( x , t ) = \frac{A}{g} {\sum }_{n = 0}^{∞} ( {C}_{n} + \frac{{H}_{n}}{{ω}^{2}} ) sin ( {k}_{n} t ) sin ( {ω}_{n} t ) & ( equation 9 )\end{matrix}$$

Variables of the above equations 5 to 9 are calculated by equations 10 to 13 below.

$$\begin{matrix}{ω}_{n}^{2} = g {k}_{n} tanh ( {k}_{n} h ) & ( equation 10 ) \\ {k}_{n} = \frac{2 n + 1}{L} π & ( equation 11 ) \\ {H}_{n} = {ω}^{3} ( \frac{4}{L} ) ( \frac{{( - 1 )}^{n}}{{k}_{n}^{2}} ) & ( equation 12 ) \\ {C}_{n} = \frac{{H}_{n}}{{ω}_{n}^{2} - {ω}^{2}} & ( equation 13 )\end{matrix}$$

In this case, A is an amplitude of the external excitation, g is an acceleration of gravity, and a coefficient kₙ is referred to as a wave number. In the present invention, the wavenumbers corresponding only to odd-numbered terms are included, therefore, kₙ=1π, 3π, 5π, . . . is used. In order to calculate the natural frequencies of the entire wave numbers, it can be calculated using ′kₙ=nπ/L′ instead of equation 11 above.

The proposed solution takes only the so-called gravity wave expressing a motion of the free surface into consideration. Another wave is a wave referred to as an acoustic wave. The acoustic wave generally has a natural frequency greater than a natural frequency of the gravity wave, and is generally greater than 100 Hz.

Accordingly, these sound waves are not as dominant as the gravity waves when considering seismic loads, and are generally considered only when solving the shock wave problem. For the system as shown in FIG. 5, the natural frequency of the acoustic wave may be calculated by equation 14 below.

$${ω}_{n}^{2} = {c}^{2} ( \frac{n π}{L} + \frac{2 n + 1}{2 h} π ) \qquad ( Equation 14 )$$

In this case, c is a wave speed in the fluid.

In 2012, in a state where a water pool having a width of 0.96 m and a height of 1.0 m is filled with water to a depth of 0.624 m, Goudarzi and Sabbagh-Yzdi, Iranian scientists, applied an external excitation having 0.7017 Hz with an amplitude of 0.005 m, analyzed the behavior of the internal fluid, calculated the behavior of the fluids using the linear theory, and then compared the calculated behavior of the fluids with experimental results. As a result of the study, the fluid behavior predicted by the linear theory was very similar to the experimental result. In the present invention, a behavior of the fluid was analyzed using the linear theory, and it was also possible to obtain the result of the analysis, which was found to be the same as the result of the study of Goudarzi and Sabbagh-Yazdi.

In the present invention, when a water pool having a width of 0.52 m and a height of 0.835 m is filled with water to a depth of 0.61 m, and an external excitation of 10 Hz having an amplitude of 0.005 m is applied, the fluid behavior was analyzed using the CFD analysis and the linear theory, respectively. Here, as shown in FIGS. 6A, 6B, and 6C, the height change of the fluid on the left wall of the water pool calculated using the linear theory is very different from that calculated using the CFD analysis.

Through this, it is expected that the error will be very large when predicting the sloshing of the fluid with respect to the external excitation with a relatively high frequency using the existing linear theory.

Meanwhile, the linear theory proposed by Faltinsen relatively well predicts the sloshing of the fluid in the range where the frequency of the external excitation is not significantly different from the natural frequency of a first mode of the fluid contained in the pool.

However, when a frequency of the external excitation is increased, it was not possible to predict the sloshing behavior of the fluid through the existing linear theory. Therefore, in the present invention, when the frequency of the external excitation is less than twice the natural frequency of the first mode of the water contained in the water pool, the sloshing behavior of the fluid is predicted using the conventional linear theory, wherein, when the frequency of the external excitation is greater than twice the natural frequency of the first mode of the water contained in the water pool, a new equation capable of analyzing the sloshing behavior of the fluid is presented.

That is, equations 8 and 9 of the existing linear theory, when rewritten in terms of ω and ωₙ, become as equations 15 to 17 below.

$$\begin{matrix} ξ ( x , t ) = {ξ}_{1} ( x , t ) + {ξ}_{2} ( x , t ) & ( equation 15 ) \\ \begin{matrix} {ξ}_{1} ( x , t ) = \frac{A}{g} ( x {ω}^{2} + {\sum }_{n = 1}^{∞} {C}_{n} ω sin ( {k}_{n} x ) ) sin ( ω t ) \\ = \frac{A}{g} ( x {ω}^{2} + {\sum }_{n = 1}^{∞} ( \frac{4}{L} ) ( \frac{{( - 1 )}^{n + 1}}{{k}_{n}^{2}} ) \frac{{ω}^{4}}{{ω}_{n}^{2} - {ω}^{2}} \\ sin ( {k}_{n} x ) ) sin ( ω t )\end{matrix} & ( equation 16 ) \\ \begin{matrix}{ξ}_{2} ( x , t ) = \frac{A}{g} {\sum }_{n = 1}^{∞} {ω}_{n} ( {C}_{n} + \frac{{H}_{n}}{{ω}^{2}} ) sin ( {k}_{n} t ) sin ( {ω}_{n} t ) \\ = \frac{A}{g} {\sum }_{n = 1}^{∞} ( \frac{4}{L} ) ( \frac{{( - 1 )}^{n + 1}}{{k}_{n}^{2}} ) \frac{{ω}_{n} ω}{{ω}_{n}^{2} - {ω}^{2}} \text{?} sin ( {k}_{n} t ) sin ( {ω}_{n} t )\end{matrix} \\ \text{?} \text{indicates text missing or illegible when filed} & ( equation 17 )\end{matrix}$$

Variables of equations 15 to 17 are calculated by equations 18 to 21 below.

$$\begin{matrix}{ω}_{n}^{2} = g {k}_{n} tanh ( {k}_{n} h ) & ( equation 18 ) \\ {k}_{n} = \frac{2 n - 1}{L} π & ( equation 19 ) \\ {H}_{n} = {ω}^{3} ( \frac{4}{L} ) ( \frac{{( - 1 )}^{n + 1}}{{k}_{n}^{2}} ) & ( equation 20 ) \\ {C}_{n} = \frac{{H}_{n}}{{ω}_{n}^{2} - {ω}^{2}} & ( equation 21 )\end{matrix}$$

In this case, A is the amplitude of the external excitation, g is the acceleration of gravity, the coefficient kₙ is the wave number the same as in the conventional linear equation, wherein the wavenumbers, kₙ=1π, 3π, 5π, . . . , corresponding only to the odd-numbered terms are considered. In addition, Cₙ and Hₙ are coefficients for the natural vibration of the nth mode of the water, which determines the amplitude of the fluid in the water pool.

The calculation of the height change value ξ1 of the fluid due to the frequency of the external excitation among the methods proposed in one embodiment of the present invention is described as follows.

In a formula for ξ₁(x, t), that is, in equation 16, the amplitude of sin(ωt), that is,

$$\frac{A}{g} ( x {ω}^{2} + {\sum }_{n = 1}^{∞} ( \frac{4}{L} ) ( \frac{{( - 1 )}^{n + 1}}{{k}_{n}^{2}} ) \frac{{ω}^{4}}{{ω}_{n}^{2} - {ω}^{2}} sin ( {k}_{n} x ) )$$

increases as ω w increases.

Here, because ξ₁(x, t) is a linearized solution, an error due to linearization may increase when Ω is large. Therefore, with an appropriate threshold having been selected, provided the amplitude is adjusted in a case when Ω is larger than the threshold, it may be expected that the error with the actual phenomenon will be reduced.

In the present invention, a threshold is defined, through a simulation in advance, as twice the natural frequency Ω₁ of a first mode of the water, that is 2Ω₁, and in case of Ω≥2Ω₁, ξ₁(x, t) in which Ω is replaced by Ω′=2Ω₁ is derived as follows.

$${ξ}_{1} ( x , t ) = \{ \begin{matrix}\frac{A}{g} ( x {ω}^{2} + {\sum }_{n = 1}^{∞} ( \frac{4}{L} ) ( \frac{{( - 1 )}^{n + 1}}{{k}_{n}^{2}} ) \frac{{ω}^{4}}{{ω}_{n}^{2} - {ω}^{2}} sin ( {k}_{n} x ) ) sin ( ω t ) , & ω < 2 {ω}_{1} \\ \frac{A}{g} ( x {ω}^{2} + {\sum }_{n = 1}^{∞} ( \frac{4}{L} ) ( \frac{{( - 1 )}^{n + 1}}{{k}_{n}^{2}} ) \frac{{ω}^{4}}{{ω}_{n}^{2} - {ω}^{2}} sin ( {k}_{n} x ) ) sin ( ω t ) , & ω \geq 2 {ω}_{1}\end{matrix} \qquad ( equation 22 )$$

In case of Ω≥2Ω₁|, ξ₂(x, t) expressed in a form of equation 16 is as follows.

$$\begin{matrix}{ξ}_{1} ( x , t ) = \frac{A}{g} ( x {{ω}^{′}}^{2} + {\sum }_{n = 1}^{∞} {C}_{n}^{′} {ω}^{′} sin ( {k}_{n} x ) ) sin ( ω t ) & ( equation 23 ) \\ {C}_{n}^{′} = \frac{{H}_{n}^{′}}{{ω}_{n}^{2} - {{ω}^{′}}^{2}} & ( equation 24 ) \\ {H}_{n}^{′} = {{ω}^{′}}^{3} ( \frac{4}{L} ) ( \frac{{( - 1 )}^{n + 1}}{{k}_{n}^{2}} ) & ( equation 25 ) \\ {k}_{n} = \frac{2 n - 1}{L} π & ( equation 26 ) \\ {ω}^{′} = 2 {ω}_{1} & ( equation 27 )\end{matrix}$$

In equation 23, C′ₙ and H′ₙ are coefficients that determine an amplitude of the sloshing ξ1 of the fluid due to the external excitation under the condition of Ω≥2Ω₁|, and kₙ is a wave number, wherein the wavenumbers, kₙ=1π, 3π, 5π, . . . , corresponding only to the odd-numbered terms are considered.

Here, calculation of the height change value ξ2 of the fluid due to the convection of the fluid contained in the water pool among the methods proposed in the embodiment of the present invention is corrected.

That is, in the case of Ω≥2Ω₁, when the calculation result using ξ₂(x, t) is compared with the results of existing experiments and analytical studies, a difference therebetween showed a level of difference that was difficult to accept in actual situations, whereby needs to be corrected. Meanwhile, according to existing experiment and analytical studies, the behavior of the fluid in the water pool follows the behavior of the natural vibration of the first mode of the fluid.

That is,

$$\frac{A}{g} {ω}_{1} ( {C}_{1} + \frac{{H}_{1}}{{ω}^{2}} ) sin ( {k}_{1} t ) sin ( {ω}_{1} t ) = \frac{A}{g} ( \frac{4}{L} ) ( \frac{{( - 1 )}^{2}}{{k}_{1}^{2}} ) \frac{{ω}_{1}^{3} ω}{{ω}_{1}^{2} - {ω}^{2}} sin ( {k}_{1} t ) sin ( {ω}_{1} t ) ,$$

the first term of ξ₂(x, t) in equation 17, becomes the most influential term of ξ₂(x, t). Therefore, the first term was corrected in the present invention, whereby a value of the whole ξ₂(x, t) was corrected. expresses the behavior due to the natural frequency Ωn of water, but it was assumed, due to

ξ₂(x, t) expresses the behavior due to the natural frequency Ωn of water, but it was assumed, due to the effect of linearization, that at least the amplitude

$$\frac{A}{g} {ω}_{1} ( {C}_{1} + \frac{{H}_{1}}{{ω}^{2}} )$$

B of a term representing the natural vibration of the first mode was related to the amplitude

$$\frac{A}{g} ( x {{ω}^{′}}^{2} + {\sum }_{n = 1}^{∞} {C}_{n}^{′} {ω}^{′} sin ( {k}_{n} x ) )$$

of ξ₁(x, t). Specifically, it was assumed that the two amplitudes were proportional at

$$x = \frac{L}{2} ,$$

the leftmost area of the water pool. That is, it was assumed as equation 28 below.

$$\frac{A}{g} {ω}_{1} ( {C}_{1} + \frac{{H}_{1}}{{ω}^{2}} ) = k [ \frac{- L}{2} \cdot {{ω}^{′}}^{2} + {\sum }_{n = 1}^{∞} {C}_{n}^{′} {ω}^{′} sin ( {k}_{n} ( \frac{- L}{2} ) ) ] \qquad ( equation 28 )$$

where, k is a constant that is a scaling factor associated with Ω.

That is, a linear equation with respect to Ω is as equation 29 below.

$$\frac{{H}_{1}}{{ω}^{2}} = ( \frac{4}{L} ) ( \frac{{( - 1 )}^{2}}{{k}_{1}^{2}} ) ω \qquad ( equation 29 )$$

where, C₁ is used to find k.

First, a linear approximation formula C̅₁(Ω) as equation 30 below was found using C₁(Ω) values when Ω changes from 3 Hz to 10 Hz.

[symbol]

(Ω)=Ω+b (equation 30)

where, a and b are coefficients of the linear approximation formula for obtaining C̅₁(Ω), which is a linear approximation value of C₁(Ω), and because Ω′=2Ω₁ was assumed as the threshold in ξ₁(x, t), it was expected to satisfy that C₁(Ω′)=C̅₁(Ω′), but the result appeared differently.

When the frequency of the excitation is Ω, since the amplitude of the first term was assumed to be k times the linearized amplitude, similarly, the slope of the linear approximation formula C̅₁(Ω)| was assumed to be k times the slope of the straight line passing through (0, b) and (Ω, C₁(Ω′)). That is, it may be expressed as equations 31 and 32 below.

$$\begin{matrix}k \frac{{C}_{1} ( {ω}^{′} ) - b}{ω} = a & ( equation 31 ) \\ k = \frac{a ω}{{C}_{1} ( {ω}^{′} ) - b} & ( equation 32 )\end{matrix}$$

Therefore, finally, it may be expressed as equation 33 below.

$${ξ}_{2} ( x , t ) = \{ \begin{matrix}\frac{A}{g} {\sum }_{n = 1}^{∞} {ω}_{n} ( {C}_{n} + \frac{{H}_{n}}{{ω}^{2}} ) sin ( {k}_{n} x ) sin ( {ω}_{n} t ) , & ω < 2 {ω}_{1} \\ \frac{A}{g} K ωsin ( {k}_{1} t ) sin ( {ω}_{1} t ) + \frac{A}{g} {\sum }_{n = 1}^{∞} \text{?} ( {C}_{n} + \frac{{H}_{n}}{{ω}^{2}} ) sin ( {k}_{n} t ) sin ( {ω}_{n} t ) , & ω \geq 2 {ω}_{1}\end{matrix} \\ \text{?} \text{indicates text missing or illegible when filed} \qquad ( equation 33 )$$

At this time, the amplitude correction coefficient K for the sloshing of the primary mode of the fluid is calculated by equation 34 below.

$$K = [ \frac{- L}{2} \cdot {{ω}^{′}}^{2} + {\sum }_{n = 1}^{∞} {C}_{n}^{′} {ω}^{′} sin ( {k}_{n} ( \frac{- L}{2} ) ) ] \frac{a}{{C}_{1} ( {ω}^{′} ) - b} \qquad ( equation 34 )$$

In case of utilizing the method proposed in the present invention, it was possible to obtain a height change of the free surface similar to a result of the CFD analysis not only for the excitation of low frequencies, which are similar to natural oscillation frequencies of the primary mode of water, but also for the excitation of high frequencies.

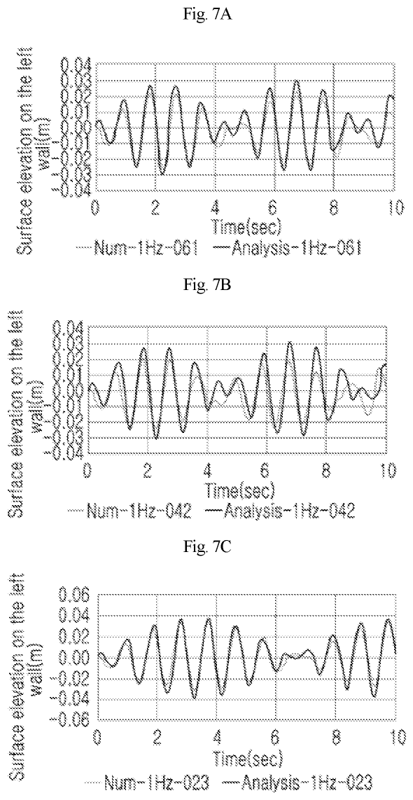

In order to verify the method proposed in the present invention, it was assumed states where water is filled with various depths (0.61 m, 0.42 m, and 0.23 m) in a water pool, which is 0.52 m wide and 0.815 m high. Then, when vibrations of various frequencies (1 Hz to 30 Hz) are applied with an amplitude of 0.005 m, height changes of the free surface on the left wall of the water pool were predicted by the method proposed in the present invention, and the predicted height changes of the free surface were compared with results of the CFD analysis, thereby verifying the method proposed in the present invention (see FIG. 7A, FIG. 7B, and FIG. 7C). FIG. 7A-7C illustrate graphs each showing a comparison of the height changes of the free surface on the left wall surface during excitation of 1 Hz.

As shown in FIG. 6B, when a behavior of the free surface of the fluid is analyzed for a state of excitation of 10 Hz using the conventional linear theory, the amplitude of the free surface of the fluid appeared to be significantly small compared with a result of the CFD analysis.

FIG. 6A illustrates graphs, for excitations of 0.7 Hz and FIG. 6B for excitations of 10 Hz, respectively, showing a comparison of the “‘behavior of the fluid predicted using the linear theory’ (analytical results in this study)” with “experimental results” and/or “'CFD results' (previous analytical results)”.

Besides, the cycle of the change of the free surface of the fluid appeared to be the same as the cycle of the external excitation of frequency of 10Hz, thereby appearing differently from results of the CFD analysis.

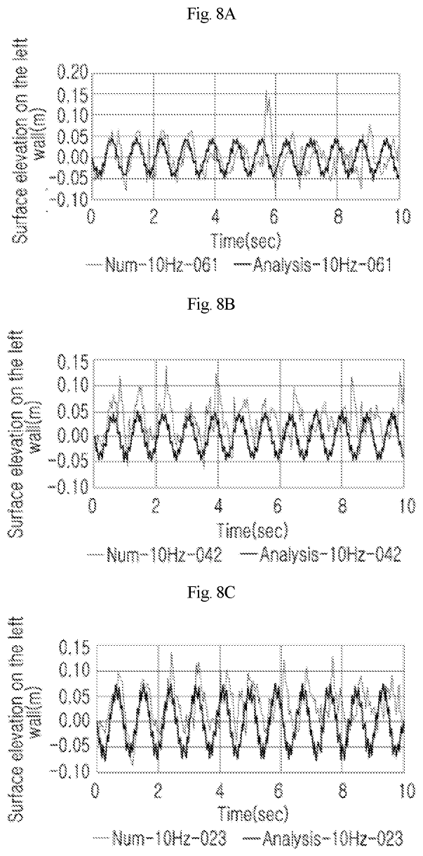

On the other hand, in a result calculated by the proposed method of the present invention, as shown in FIG. 8A-8C, not only a range of height changes of a free surface is similar to a result of the CFD but also a pattern of height changes of the free surface is similar to a result of the CFD. Here, FIG. 8A-8C are graphs showing a comparison of height changes of the free surface on the left wall surface for the excitation of 10 Hz.

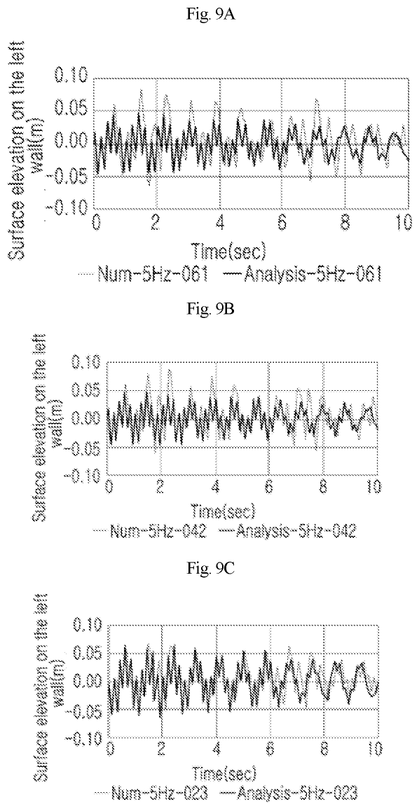

Similarly to the excitation condition of 10 Hz, under the excitation condition of 5 Hz, a range of and a pattern of height changes of the free surface calculated by the proposed method of the present invention appeared similar to results of the CFD. FIG. 9A-9C show the comparison of the changes in free surface height on the left wall surface for the excitation frequency of 5 Hz.

In addition, in a state where the depth of water was fixed at 0.23 m, height changes of the free water surface when excitation of 2 Hz, 3 Hz, and 4 Hz was applied were calculated by the proposed method of the present invention, and calculated height changes were compared with results of the CFD analysis. Accordingly, it was confirmed that the height changes of the free surface predicted using the proposed method of the present invention in all of three conditions were similar to the results of the CFD analysis.

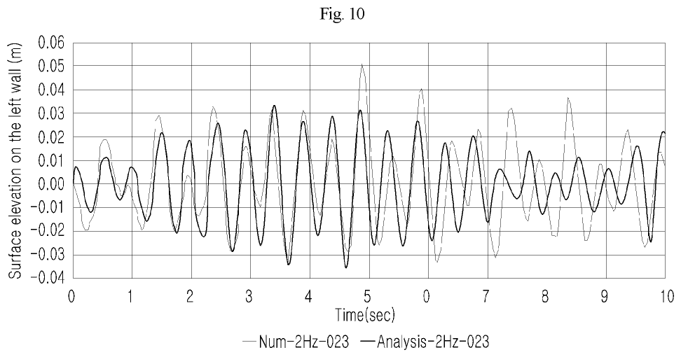

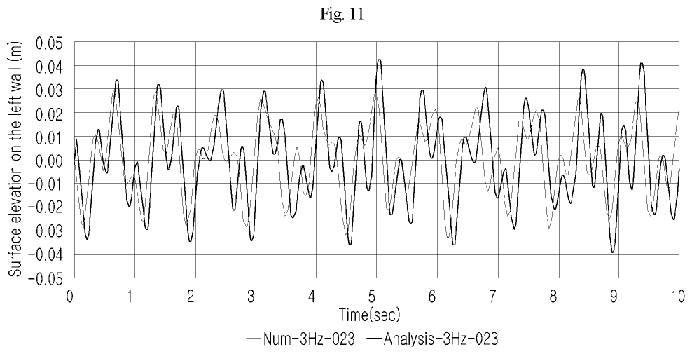

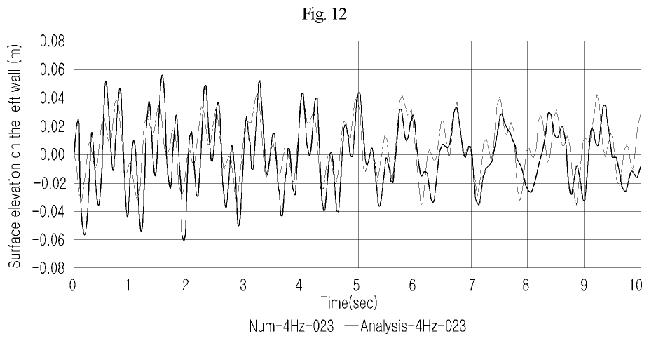

FIG. 10, FIG. 11, and FIG. 12 show the changes in free surface height on the left wall surface for the excitation frequencies of 2 Hz, 3 Hz, and 4 Hz, respectively.

In addition, in a state where the depth of water is fixed at 0.23 m and in a state where water is excited very quickly with 20 Hz and 30 Hz, the height changes of the free surface were calculated by the proposed method of the present invention, and calculated height changes were compared with results of the CFD analysis.

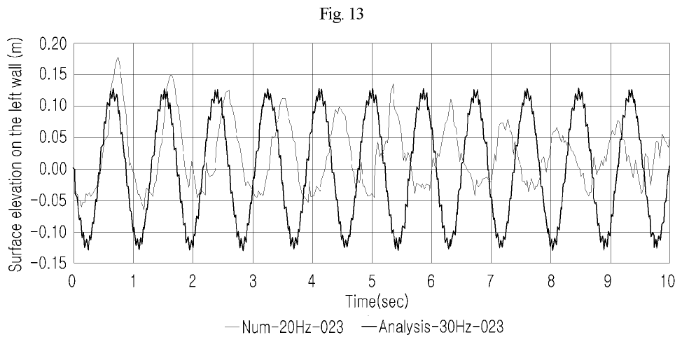

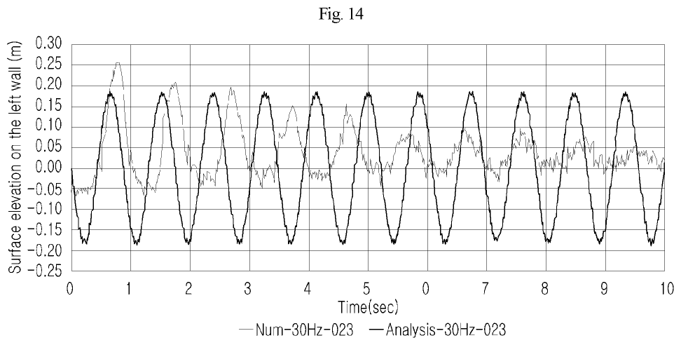

FIG. 13 and FIG. 14 show the changes in free surface height on the left wall surface for the excitation frequencies of 20 Hz, and 30 Hz, respectively.

That is, at an initial stage of excitation, the height changes of the free surface predicted using the proposed method of the present invention looked similar to the results of the CFD analysis. However, as time continues, the height of the free surface calculated using the proposed method of the present invention appeared higher than the results of the CFD analysis. Accordingly, it was recognized that, when the proposed method of the present invention is used, the height of the free surface is predicted more conservatively.

Due to nonlinear characteristics such as the viscosity and the surface tension of the fluid, even though the height change cycle of the fluid predicted by the CFD appeared longer compared with the value predicted using the proposed method of the present invention, there was no significant difference from the natural frequency of the primary mode of the fluid.

The cycle of the sloshing of the fluid (natural frequency of the primary mode of the fluid) in the proposed method of the present invention is 1.15 Hz (excitation conditions of 20 Hz and 30 Hz), and the cycles of the sloshing of the fluid calculated from the results of the CFD analysis are 1.12 Hz (an excitation condition of 20 Hz) and 1.0 Hz (an excitation condition of 30 Hz).

According to the apparatus for analyzing sloshing behavior of a fluid contained in the water pool and the method thereof according to the embodiment of the present invention described above, in the range of various external excitations, it was possible to calculate the behavior of the free surface of the fluid, which is similar to the results predicted by the CFD analysis method.

Accordingly, the calculation method of the behavior of the fluid proposed in the present invention may be very effectively utilized for analyzing the behavior of the fluid at the conceptual design stage of the spent nuclear fuel storage pool (or a fluid storage tank having a structure similar thereto).

Meanwhile, the method of analyzing the behavior of the fluid contained in the water pool according to an embodiment of the present invention may also be implemented as a computer-readable code on a computer-readable recording medium. Here, the computer-readable recording medium includes all kinds of recording devices in which data that may be read by a computer system is stored.

For example, the computer-readable recording medium may be a ROM, a RAM, a CD-ROM, a magnetic tape, a hard disk, a floppy disk, a removable storage device, a flash memory, an optical data storage device, and the like.

In addition, the computer readable recording medium may be distributed in a computer system connected to a computer communication network and may be stored and executed as a code readable in a distributed manner.

Although the preferred embodiments of the apparatus for analyzing sloshing behavior of the fluid contained in the water pool and the method thereof according to the above-stated present invention have been described, the present invention is not limited thereto but may be variously modified and embodied within the scope of the claims, the detailed description of the invention, and the accompanying drawings, wherein the variously modified and embodied embodiments also belong to the present invention.

1. An apparatus for analyzing sloshing behavior of a fluid contained in a water pool, the apparatus comprising:
a user input module outputting a specific input signal of a user according to a request of the user;
a first calculation module receiving information data, on a width of the water pool, a height of the fluid contained in the water pool, and a width and cycle of an external excitation, output according to the specific input signal of a corresponding user from the user input module and, on a basis thereof, calculating a natural frequency of an nth (n=1, 2, 3, . . . ) mode of the fluid according to a movement of a free surface of the fluid as well as a frequency of the external excitation;
a comparison determination module comparing values, of the frequency of the external excitation and the natural frequency of the nth mode of the fluid calculated from the first calculation module, with each other, thereby determining whether the frequency of the external excitation is greater than twice the natural frequency of a primary mode of the fluid contained in the water pool;
a second calculation module, when the frequency of the external excitation is determined to be greater than twice the natural frequency of the primary mode of the fluid contained in the water pool by the comparison determination module, calculating a height change value of the fluid due to the frequency of the external excitation using the values, of the frequency of the external excitation and the natural frequency of the nth mode of the fluid, calculated from the first calculation module along with the information data, on the width of the water pool, the height of the fluid contained in the water pool, and the width and frequency of the external excitation, output according to the specific input signal of the corresponding user from the user input module;
a third calculation module, when the frequency of the external excitation is determined to be greater than twice the natural frequency of the primary mode of the fluid contained in the water pool by the comparison determination module, calculating a height change value of the fluid due to convection of the fluid contained in the water pool using the values, of the frequency of the external excitation and the natural frequency of the nth mode of the fluid, calculated from the first calculation module along with the information data, on the width of the water pool, the height of the fluid contained in the water pool, and the width and frequency of the external excitation, output according to the specific input signal of the corresponding user from the user input module;
a fourth calculation module summing the height change value of the fluid due to the frequency of the external excitation, calculated from the second calculation module, and the height change value of the fluid due to the convection of the fluid contained in the water pool, calculated from the third calculation module, thereby calculating a sloshing value of the fluid contained in the water pool;
a display module, displaying on a display screen information on a sloshing behavior analysis of the fluid contained in the water pool on the basis of the sloshing value of the fluid contained in the water pool calculated from the fourth calculation module; and
a control module receiving the sloshing value, calculated from the fourth calculation module according to the specific input signal of the corresponding user from the user input module, of the fluid contained in the water pool and, on the basis of the sloshing value, generating information on the sloshing behavior analysis of the fluid contained in the water pool, thereby controlling operations of the user input module, the first to fourth calculation modules, the comparison determination module, and the display module to allow the same to be displayed in a form of a text or graph on a display screen of the display module to be visually seen by the corresponding user.

2. The apparatus of claim 1, wherein a storage module is further included, the storage module, according to a control of the control module, establishing a database (DB) for at least a piece of information among pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, calculated from the first to fourth computation modules, thereby storing the same.

3. The apparatus of claim 1, wherein a communication module is further included, the communication module, according to a control of the control module, transmitting at least a piece of information among pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, calculated from the first to fourth computation modules, to an external user terminal through a communication network.

4. The apparatus of claim 3, wherein the external user terminal receiving at least the piece of information among the pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, transmitted from the communication module through an application service previously installed and related to the sloshing behavior analysis of the fluid, thereby, on the basis of the same, displaying in the form of the text or graph on the display screen of the corresponding user terminal the same to be visually seen by the corresponding user.

5. The apparatus of claim 1, wherein a sound output module is further included, the sound output module, according to a control of the control module, outputting the information on the sloshing behavior analysis of the fluid contained in the water pool by a sound to allow the sound to be acoustically heard by the user.

6. The apparatus of claim 1, wherein the fluid is composed of cooling water for cooling a nuclear fuel assembly used for nuclear power generation.

7. The apparatus of claim 1, wherein the water pool is composed of a spent nuclear fuel storage pool cooling and storing the nuclear fuel assembly used for nuclear power generation in the cooling water.

8. A method of analyzing sloshing behavior of a fluid contained in a water pool, using an apparatus including a user input module, first to fourth calculation modules, a comparison determination module, a display module, and a control module, the method comprising:
(a) outputting a specific input signal of a user according to a request of the user through the user input module;
(b) on a basis of information data, on a width of the water pool, a height of the fluid contained in the water pool, and a width and cycle of an external excitation, output according to the specific input signal of the user in step (a), calculating a natural frequency of an nth (n=1, 2, 3, . . . ) mode of the fluid according to a free surface movement of the fluid as well as a frequency of the external excitation through a first calculation module;
(c) through the comparison determination module, comparing values of the frequency of the external excitation and the natural frequency of the nth mode of the fluid calculated in step (b) with each other, thereby determining whether the frequency of the external excitation is greater than twice the natural frequency of the primary mode of the fluid contained in the water pool;
(d) as a determination result in step (c), when the frequency of the external excitation is greater than twice the natural frequency of the primary mode of the fluid contained in the water pool, calculating a height change value of the fluid due to the frequency of the external excitation through the second calculation module using the values of the frequency of the external excitation and the natural frequency of the nth mode of the fluid, calculated in step (b) along with the information data, on the width of the water pool, the height of the fluid contained in the water pool, and the width and frequency of the external excitation, output according to the specific input signal of the corresponding user in step (a);
(e) as a determination result in step (c), when the frequency of the external excitation is greater than twice the natural frequency of the primary mode of the fluid contained in the water pool, calculating a height change value of the fluid due to the convection of the fluid contained in the water pool through the third calculation module using the values of the frequency of the external excitation and the natural frequency of the nth mode of the fluid, calculated in step (b) along with the information data, on the width of the water pool, the height of the fluid contained in the water pool, and the width and frequency of the external excitation, output according to the specific input signal of the corresponding user in step (a);
(f) through the fourth calculation module, summing the height change value of the fluid due to the frequency of the external excitation calculated in step (d) and the height change value of the fluid due to the convection of the fluid contained in the water pool calculated in step (e), thereby calculating a sloshing value of the fluid contained in the water pool; and
(g) through the control module, generating information on a sloshing behavior analysis of the fluid contained in the water pool on the basis of the sloshing value of the fluid contained in the water pool calculated in step (f) according to the specific input signal of the corresponding user in step (a), thereby displaying in a form of a text or graph on a display screen of the display module the same to allow the same to be visually seen by the corresponding user.

9. The method of claim 8, further comprising:
after step (g), through the control module, establishing a database (DB) of at least a piece of information among pieces of information on the natural frequency of the nth mode of the fluid according to the free surface movement of the fluid calculated in step (b), the height change value of the fluid due to the frequency of the external excitation calculated in step (d), the height change value of the fluid due to the convection of the fluid contained in the water pool calculated in step (e), the sloshing value of the fluid contained in the water pool calculated in step (f), and the sloshing behavior analysis of the fluid contained in the water pool generated in step (g), thereby storing the same into a separate storage module.

10. The method of claim 8, further comprising:
after step (g), through the control module, transferring at least a piece of information among pieces of information on the natural frequency of the nth mode of the fluid according to the free surface movement of the fluid calculated in step (b), the height change value of the fluid due to the frequency of the external excitation calculated in step (d), the height change value of the fluid due to the convection of the fluid contained in the water pool calculated in step (e), the sloshing value of the fluid contained in the water pool calculated in step (f), and the sloshing behavior analysis of the fluid contained in the water pool generated in step (g) to a separate communication module, thereby allowing the same to be transmitted to an external user terminal.

11. The method of claim 10, further comprising:
on the basis of at least the piece of information among the pieces of information on the natural frequency of the nth mode of the fluid according to the free surface movement of the fluid, the height change value of the fluid due to the frequency of the external excitation, the height change value of the fluid due to the convection of the fluid contained in the water pool, the sloshing value of the fluid contained in the water pool, and the sloshing behavior analysis of the fluid contained in the water pool, transmitted from the communication module through an application service installed in the external user terminal and related to the sloshing behavior analysis of the fluid, displaying in the form of the text or graph on a display screen of the corresponding user terminal the same, thereby allowing the information to be visually seen by the corresponding user.

12. The method of claim 8, further comprising:
after step (g), through the control module, transferring the information on the sloshing behavior analysis of the fluid contained in the water pool to a separate sound output module outputting the information by a sound, thereby allowing the sound to be acoustically heard by the user.

13. The method of claim 8, wherein, in step (b), the fluid is composed of cooling water for cooling a nuclear fuel assembly used for nuclear power generation.

14. The method of claim 8, wherein, in step (b), the water pool is composed of a spent nuclear fuel storage pool cooling and storing the nuclear fuel assembly used for nuclear power generation in the cooling water.

15. A computer-readable recording medium having recorded thereon a computer program capable of executing the method of claim 8 by a computer.
